(19) United States
(12) Patent Application Publication
(10) Pub. No.: US 2008/0037019 A1
(43) Pub. Date: Feb. 14, 2008

(54) COLOR MEASURING HEAD

(75) Inventors: Beat Frick, Buchs (CH); Harald Ammeter, Zurich (CH)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(73) Assignee: X-RITE EUROPE AG, Regensdorf (CH)

(21) Appl. No.: 11/834,980

(22) Filed: Aug. 7, 2007

(30) Foreign Application Priority Data
Aug. 8, 2006 (EP) 06118566.6-1234

(51) Int. Cl. G01N 21/25

(52) U.S. Cl. 356/406

(57) ABSTRACT

A photoelectric color measuring head for measuring color properties of a measurement object includes an illumination device for exposing the measurement object to illuminating light and a wavelength-range-selective photoelectric receiver device (40) which intercepts measurement light remitted by the illuminated measurement object and converts it into corresponding electrical measurement signals. The illumination device includes an essentially white light-emitting diode (30) and means (60) for defining the angle of incidence range, so that the measurement object receives light only within an angle of incidence range, standardized for color measurement applications, of preferably 45°+/−5-10°. The receiver device includes a sensor field consisting of a multitude of photoelectric sensor pixels arranged in a line and the sensor pixels are made sensitive to different wavelength ranges through previously arranged color filters (420). The sensor field is in the form of a chip and is mounted together with the light-emitting diode (30) on a shared printed circuit board (1). The color filters (420) are arranged on an elongated transparent filter carrier and mounted directly above the light inlet window of the sensor field. The sensor field is formed together with the color filters as a flat sandwich structure and surrounded by a protective frame and cast with an opaque sealing compound. The color measuring head has an extremely small structural volume and can be produced with relatively limited construction resources.

### BACKGROUND OF THE INVENTION

1. Field of the Invention

The invention relates to a photoelectric color measuring head for measuring color properties of a measurement object according to the introductory clause of the independent claim 1.

2. Description of the Prior Art

Color measuring heads of the generic type are the central component of photoelectric color measurement devices in the widest sense. The color measuring heads serve to expose a measurement object to light and to receive the measurement light reflected by the measurement object, to separate it into wavelength ranges and to convert the light portions of the individual wavelength ranges into corresponding electrical measurement signals. It is possible to determine from these the values of interest on the measurement object, for example color values, color density values, etc. When the light source is disconnected, the color measuring heads can also be used for emission, transmission and ambient light measurements.

The exposure of the measurement object to illuminating light and the detection of the reflected measurement light are realized according to standardized measurement geometries. One of the most common measurement geometries thereby provides for an illumination within a range of angles of incidence from 45°+/−5-10° and a measurement within a range of angles of reflection from 0°+/−5-10° (in relation to normal in relation to the measurement object at the measurement location). The appropriate standardized installations also define, however, some other measurement geometries. The phrase “standardized ranges of angles of incidence and reflection for color measurement applications” is hereinafter understood to mean the afore-mentioned standardized 45°/0° measurement geometry and the associated angle ranges fixed in the relevant standards.

In modern color measuring heads light-emitting diodes are already widely used as light sources. Amongst others, high performance white light-emitting diodes with lambertian radiation characteristics are used. The division of the measurement light into individual wavelength ranges is realized according to the desired resolution either by means of a spectrometer or by means of a larger or smaller number of different color filters.

Integrated arrangements of photoelectric converter elements, so-called sensor fields in CMOS or CCD technology, are widely used today for the conversion of the measurement light portions divided according to wavelength ranges into corresponding electrical signals. One-dimensional arrangements, so-called line sensors, or two-dimensional arrangements, so-called area sensors, can thereby be used. Line sensors provide either a local resolution according to image points or a resolution according to wavelength ranges if the converter elements are exposed to light from different wavelength ranges. Area sensors can be used in one dimension for a local resolution and in another dimension for a resolution according to wavelength ranges. Resolution according to wavelength ranges is usually realized in such a way that different color filters are arranged before the individual converter elements of the sensor field or groups of a few adjacent converter elements.

Further details concerning color measuring heads of the generic type are described for example in WO 2006/045621 A1. In particular, this document contains detailed indications concerning suitable light sources, especially light-emitting diodes, suitable color filter sets with their transmittance characteristics and suitable sensor fields. Furthermore, this document also mentions the remaining components belonging to a complete color measurement device, including electronic control of lighting and photoelectric converters.

The color measuring heads of the generic type disclosed to date are all relatively complicated and voluminous in terms of structure. They comprise a relatively large number of mechanical, optical and electrical components and can therefore only be produced with relatively great resources.

### SUMMARY OF THE INVENTION

A color measuring head of the generic type is to be improved according to the present invention in that it can be produced with extremely limited construction and assembly resources and in addition has an extremely low structural volume, thus being suitable for miniaturization. At the same time the achievable measurement performance (precision) must be comparable with that of conventional color measuring heads of the generic type.

The advantages according to the invention are achieved by a photoelectric color measuring head for measuring color properties of a measurement object, with an illumination device for exposing the measurement object to illuminating light and with a wavelength-range-selective photoelectric receiver device which intercepts measurement light remitted by the illuminated measurement object and converts it into corresponding electrical signals, whereby the illumination device comprises an essentially white light-emitting diode and means for defining the angle of incidence range, so that the measurement object receives light only within an angle of incidence range, standardized for color measurement applications, of preferably 45°+/−5-10°, and whereby the receiver device comprises a sensor field consisting of a multitude of photoelectric sensor pixels arranged in a line and the sensor pixels are made sensitive to different wavelength ranges by previously arranged color filters, wherein the sensor field is in the form of a chip and is assembled together with the light-emitting diode on a shared printed circuit board

### BRIEF DESCRIPTION OF THE DRAWINGS

The invention will be described in greater detail below by reference to the drawing, in which:

FIG. 1 shows an inclined view of an embodiment of the color measuring head according to the invention,

FIG. 2 shows a view similar to FIG. 1 but with the protective casing removed,

FIG. 3 shows an inclined view of the receiver device of the color measuring head formed as a sandwich structure,

FIG. 4 shows an inclined view of the sensor field of the color measuring head,

FIG. 5 shows an inclined view of the sensor field with previously arranged color filters,

FIG. 6 shows an inclined view of the color filters,

FIG. 7 shows a sectional view of the receiver device along line VII-VII of FIG. 3 and

FIG. 8 shows a block diagram of the most important functions of the color measuring head.

### DETAILED DESCRIPTION OF THE PREFERRED EMBODIMENTS

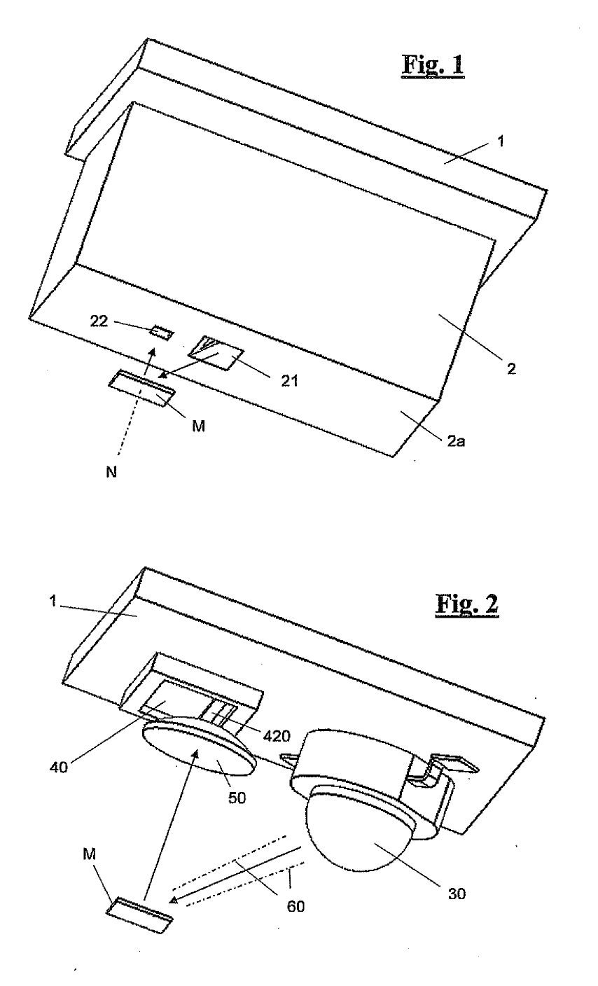

The color measuring head according to the invention is constructed on a printed circuit board 1 and surrounded by a protective casing 2 fixed to the printed circuit board. Two openings 21 and 22 are arranged on the lower side 2a of the protective casing 2 lying opposite the printed circuit board 1, through which openings 21 and 22 illuminating light can exit the protective casing and measurement light reflected by the measurement object can enter the protective casing. FIGS. 1 and 2 also show a measurement object M and the positioning of the color measuring head relative to the measurement object in practical use. The printed circuit board 1 is simultaneously a physical interface for the incorporation of the color measuring head, e.g. into a color measurement device (host device).

FIG. 2 shows the components of the color measuring head according to the invention which are most important in functional terms. These comprise an illumination device in the form of a light-emitting diode 30, a photoelectric receiver device 40, a field lens 50 and defining means 60, symbolized by dotted lines, for defining the illumination angle range on the measurement object M. The light-emitting diode 30 and the photoelectric receiver device 40 are connected in the known way electrically to lines (not shown) on the printed circuit board 1. By means of these lines, the light-emitting diode 30 and the photoelectric receiver device 40 can be supplied with power in the known way and connected to an external control.

In practical operation (for remission measurements), the measurement object M is exposed to illuminating light radiated from the light-emitting diode 30 within an angle of incidence or angle of illumination range from 45°+/−5-10° in relation to normal N at the measurement location of the measurement object M. The measurement light reflected by the measurement object M reaches, via the field lens 50, the photoelectric receiver device 40, whereby the angle of reception or interception range is 0+/−5-10°, likewise in relation to normal N on the measurement object M. The measurement light is divided in the receiver device 40, in a way to be described further, into measurement light portions of different wavelength ranges and the individual measurement light portions are converted into corresponding electrical measurement signals which can then be read via the lines on the printed circuit board 1 by the external control mentioned.

The defining of the illumination angle range results automatically from the dimensioning and arrangement of the light outlet opening 21 relative to the light-emitting diode 30.

In practice, however, intermediate walls (not shown here) are additionally provided within the protective casing 2, which also screen the receiver device 40 in a lightproof way from the light-emitting diode, so that the illuminating light cannot therefore reach the receiver device directly. Similarly, the defining of the interception angle range and the measurement range is determined by the light inlet opening 22.

The field lens 50 mounted in holding elements, not shown here, within the protective casing 2 serves essentially to define the angle range of the light incident on the sensor field. With corresponding filter design this is not compulsory, the field lens can then also be omitted, whereby the structure of the color measuring head is further simplified.

A high performance white light-emitting diode with lambertian radiation characteristics is preferably used as a light-emitting diode 30. Such light-emitting diodes are known in themselves and described for example in the afore-mentioned document WO 2006/045621 A1 with all the relevant properties. An absolutely essential property is the independence in terms of height of the color measuring head in the case of the known arrangement of the light-emitting diode, coplanar with the substrate plane, insofar as the height and the lateral offset are the same, that is to say at an illuminating angle of 45°.

The photoelectric receiver device 40 shown in detail in FIGS. 3 to 7 is formed according to a main idea of the invention as a flat sandwich structure. It comprises, as the most important components, a photoelectric sensor field 410 and a structured filter arrangement 420. The sandwich structure is shown in its entirety in FIG. 3. FIG. 7 shows a section through the sandwich structure.

The photoelectric sensor field 410 shown individually in FIG. 4 is typically a (casing-free) silicon chip produced according to CMOS technology, on which optical and electronic functions are integrated. This chip comprises a linear arrangement (line) of individual photoelectric sensor pixels which are exposed to measurement light through a light inlet window 411 formed in the chip. Each sensor pixel converts the measurement light received by it into a corresponding electrical measurement signal. The number of sensor pixels can be 134 for example. For the electrical contacting of the CMOS chip, the latter is equipped with a row of contact areas (bond pads) 412. These are connected via fine wires to corresponding contact areas on the printed circuit board 1 (wire bonding). The sensor field 410 and the chip are stuck on the printed circuit board 1 (dye bonding). Suitable sensor fields can be commercially obtained and are produced for example by Hamamatsu TAOS or IC-Haus.

The filter arrangement 420 structured according to a further main idea of the invention serves for the division of the measurement light into different wavelength ranges. It comprises a filter carrier (substrate) 421 in the form of an elongated glass rod and a number of individual color filters 422 which are arranged on the glass rod 421, for example through vapor deposition or through a spinning process. The filters are then geometrically structured photolithographically. The filters are typically produced as wafers, for example on a glass plate of 150 mm diameter, and then cut to size, similarly to the way in which silicon wafers are processed to form chips.

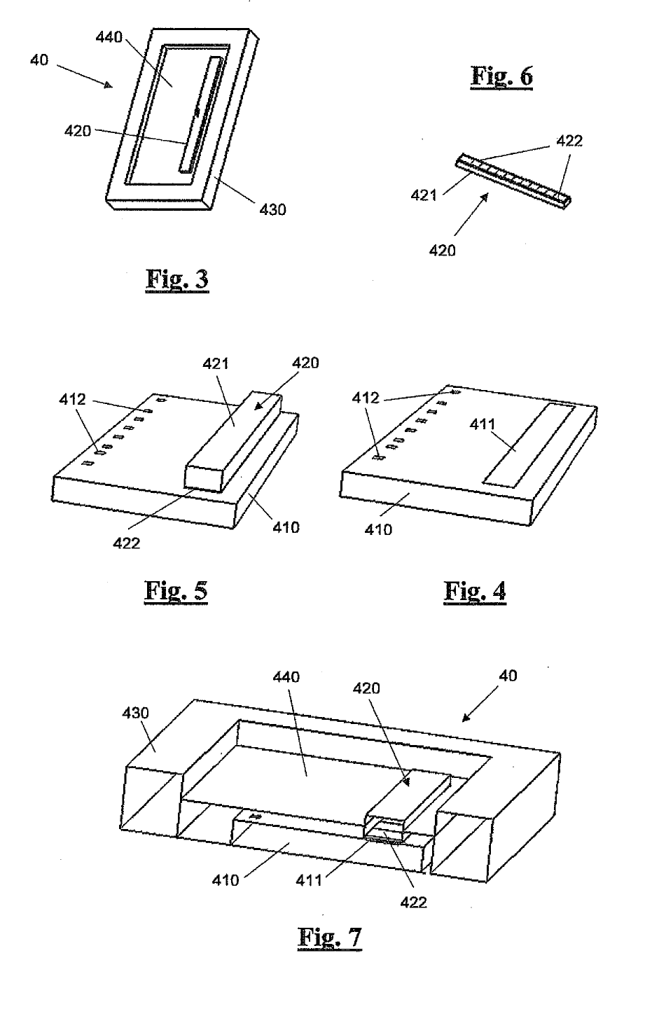

The structured filter arrangement 420 is shown individually in FIG. 6. The number of different color filters 422 depends upon the desired color resolution. Three color filters are normally necessary as a minimum, but preferably 6-8 or 12 different color filters are used. Considerations in this respect are described in detail in the already mentioned document WO 2006/045621 A1. It is of course possible, on account of the producability and yield, to distribute the number of the filters over two or more shorter filter carriers, i.e. if a filter carrier with 12 filters is critical in terms of production, two filter carriers with 6 filters each, one beside or behind the other, can be used. Furthermore it is also possible to use two or more chips for the sensor field 410 and to provide each chip with its own filter arrangement 420, whereby the filters have different characteristics in the filter arrangements, so that all in all the number of color filters corresponding to the desired resolution is available.

The structured filter arrangement 420 is arranged directly above the light sensitive area, i.e. the light inlet window 411 of the sensor field 410, whereby the color filters 422 are facing the sensor pixels of the sensor field. FIG. 5 illustrates this.

The photoelectric receiver device 40 is, as already mentioned, formed as a flat sandwich structure. The sensor field 410 is hereby surrounded by a frame 430 and cast with an opaque sealing compound 440, whereby merely the filter arrangement 420 projects out of the sealing compound. FIGS. 3 and 7 illustrate this. The sensor chip is protected through this structure and at the same time simple positioning of the filter arrangement 420 is achieved.

A process for producing a chip package with a glass covering layer is known in itself under the name ShellOP and is offered by XinTec Inc. 4Fl, No. 25, Ji-Lin Road, Chung-Li Industry Park, Tao Yuan Hsien, Taiwan, R.O.C. With this production process a wafer is embedded with the silicon chips containing the electronic and photoelectric components in a sandwich-like way between two glass plates and the chips are then singularized, together with the two glass layers. For the purposes of the present invention, the required filters can be integrated directly into the chip production process in that the lower side of the glass covering layer is vaporized before being applied to the silicon chip with a corresponding filter structure.

A further method for arranging a plurality of different filters on a silicon chip is the application of a thin layer of photostructurable varnish by spinning and subsequent photolithographic structuring. The method is widely used today in order to provide video CCDs with RGB filters. In this method the necessary number of different filter varnishes are applied with well-defined spectral characteristics one after the other directly on the pixels of the area sensor. Further details can be found for example on the website of Brewer Science's Specialty Materials Division.

The individual sensor pixels of the sensor field 410 are isothermically integrated on the chip. According to a further aspect of the invention a few (e.g. 6) sensor pixels, preferably at one end of the linear arrangement, are not exposed to measurement light and are thus used for dark measurements. With the aid of these dark measurements, compensation for the thermic drift behavior of the sensor field can be calculated. The non-exposure to measurement light can be achieved through suitable light guiding or through corresponding shadowing of the sensor pixels. Covering through metallisation during the production of the chip or covering with black photostructurable varnish are also suitable. This is obvious to the person skilled in the art and not therefore shown in the drawing.

According to a further aspect of the invention the color measuring head is equipped with electronic data capture, computing, storage and interface functions, whereby these electronic functions are arranged either in the chip of the sensor filed as ASIC or in corresponding more or less highly integrated components on the printed circuit board. These functions implement the calibration of the sensor chip, the capture of the raw data, the correction thereof, the further processing to metric data for the desired application (e.g. L,a,b color values, densities, spectra, lux, etc.) and finally communication with the superordinate device (host). The color measuring head according to the invention thus becomes an independent element which communicates with the device in which it is inserted (host), on the level of the metric data. The superordinate device (host) does not therefore need to deal with the actual data capture and conversion.

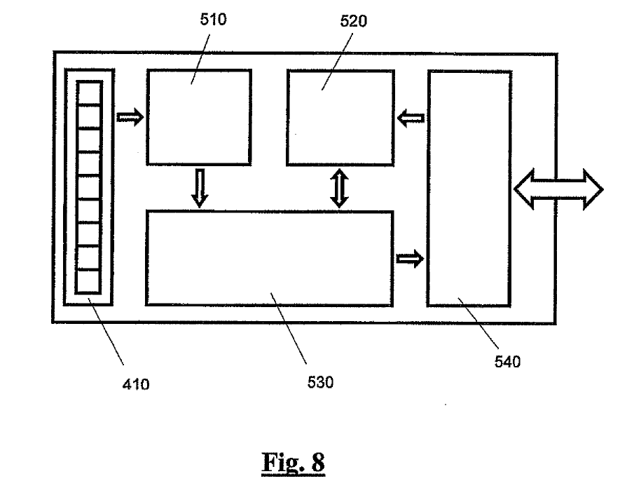

FIG. 8 shows a principle block diagram of the individual components of the functions mentioned. The raw measurement data of the light sensitive pixels of the sensor field 410 are read in the functional block 510, digitalized and intermediately stored. The functional block 520 contains stored calibration data and the associated firmware. A microprocessor 530 works with the two functional blocks 510 and 520 and also controls an interface block 540, via which communication with the host device is realized. The calculation of the desired metric data (e.g. L,a,b color values, densities, spectra, lux, etc.) takes place through the microprocessor with the aid of the data stored in the block 510 in association with the calibration data stored in the block 520. For the calibration of the color measuring head, sensor-specific data are necessary which are determined and fixedly programmed during manufacturing, as well as calibration data which are captured upon bringing into operation of the color measuring head and stored. The steps necessary for the calibration of color measurement devices are known in principle and do not therefore need any further clarification for the person skilled in the art.

As already follows from the above explanations, all critical functional components of the color measuring head are mounted on the printed circuit board 1. This allows the automated and thus cost-effective assembly of the color measuring head and also leads to an extremely small structural volume.

The color measuring head according to the invention is preferably used for remission measurement. A main field of application is for incorporated sensors for printers or in process control. The color measuring head can, however, also be incorporated into hand-held measurement devices, with which, besides remission, the emission of a monitor can also be measured, ambient light using a diffuser element or the emission from a projection wall. Furthermore, the color measuring head according to the invention can be used, possibly also omitting the light source, in goniometric or ball color measurement devices, whereby a multi-channel spectrometer is generally used.

1. Photoelectric color measuring head for measuring color properties of a measurement object, comprising:
(a) an illumination device (30) for exposing the measurement object (M) to illuminating light, and
(b) a wavelength-range-selective photoelectric receiver device (40) which intercepts measurement light remitted by the illuminated measurement object and converts it into corresponding electrical signals,
wherein the illumination device comprises an essentially white light-emitting diode (30) and means (60) for defining the angle of incidence range so that the measurement object receives light only within an angle of incidence range that is standardized for color measurement applications, and
wherein the receiver device comprises a sensor field (410) that includes a multitude of photoelectric sensor pixels arranged in a line, the sensor pixels being made sensitive to different wavelength ranges by previously arranged color filters (422), and
wherein the sensor field (410) is in the form of a chip and is assembled together with the light-emitting diode (30) on a shared printed circuit board (1).

2. Color measuring head according to claim 1, wherein the sensor field (420) is formed together with the color filters (422) as a flat sandwich structure.

3. Color measuring head according to claim 1, wherein the sensor field (410) is in the form of an integrated CMOS element.

4. Color measuring head according to claim 1, wherein the sensor field (410) comprises an elongated light inlet window (411) and wherein the color filters (422) are mounted directly above the light inlet window.

5. Color measuring head according to claim 1, wherein the color filters (422) are arranged on an elongated transparent filter carrier (421) and arranged one behind the other in a longitudinal orientation.

6. Color measuring head according to claim 1, wherein the sensor field (410) is surrounded by a protective frame (430) and cast with an opaque sealing compound (440).

7. Color measuring head according to claim 1, wherein the sensor field (410) comprises a glass covering layer and the color filters (422) are arranged on the inner side of the glass covering layer.

8. Color measuring head according to claim 1, wherein the color filters (422) are formed by photostructurable filter varnishes applied directly to the light sensitive area of the sensor field (410).

9. Color measuring head according to claim 1, wherein at one end of the sensor field (410), a plurality of sensor pixels are positioned either (i) so as to lie outside of an area exposed to the measurement light or (ii) so as to be shadowed from the measurement light.

10. Color measuring head according to claim 1, wherein the color filters (422) include at least three different color filters.

11. Color measuring head according to claim 1, wherein the light-emitting diode (30) is in the form of a high performance light-emitting diode with lambertian radiation characteristics.

12. Color measuring head according to claim 1, further comprising a field lens (50) positioned in the radiation path of the measurement light remitted by the illuminated measurement object before the color filters (422).

13. Color measuring head according to claim 1, wherein the sensor field (410) includes two or more chips, whereby a color filter arrangement (420) is assigned to each chip.

14. Color measuring head according to claim 1, wherein the receiver device is further adapted for emission measurements when the illumination device is disconnected therefrom.

15. Color measuring head according to claim 1, further comprising means for electronic data capture and storage (510).

16. Color measuring head according to claim 15, wherein the electronic functions are integrated as an application specific integrated circuit (ASIC) into the sensor field (410).

17. Color measuring head according to claim 15, wherein the electronic functions are supported by electronic components arranged on the printed circuit board (1).

18. Color measuring head according to claim 16, characterized in that the electronic functions are realized through electronic components arranged on the printed circuit board (1).

19. Color measuring head according to claim 1, further comprising electronic processing means (530) for calculating metric data.

20. Color measuring head according to claim 1, further comprising electronic interface means (540) for communication with an external device.

21. Color measuring head according to claim 1, wherein the measurement object receives light within an angle of incidence range of 45°+/−10°.
